(19) United States
(12) Patent Application Publication
(10) Pub. No.: US 2024/0349310 A1
(43) Pub. Date: Oct. 17, 2024

(54) HANDLING AN EVENT IN A SIDELINK GROUP

(71) Applicant: Nokia Technologies Oy, Espoo (FI)

(72) Inventors: Lianghai JI, Aalborg (DK); Vinh VAN PHAN, Olulu (FI); Ling YU, Espoo (FI); Sudeep HEGHE, stuttgart (DE); Nuno Manuel KIILERICH PRATAS, Aalborg (DK); Daniela LASELVA, Aalborg (DK); Berthold PANZNER, Munich (DE); Torsten WILDSCHEK, Gloucester (GB)

(21) Appl. No.: 18/293,740

(22) PCT Filed: Aug. 5, 2021
(86) PCT No.: PCT/EP2021/071883

§ 371 Date: Jan. 30, 2024

(51) Int. Cl. H04W 72/30; H04W 72/25; H04W 72/40; H04W 76/28

(52) U.S. Cl. CPC H04W 72/30; H04W 72/25; H04W 72/40; H04W 76/28

(57) ABSTRACT

A method comprising receiving a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtaining data related to an event that is to be transmitted for the groupcast, transmitting, outside the on-duration of the sidelink discontinuous reception cycle, a first indication comprising a notification regarding the event using the resource, and transmitting the data for the groupcast.

### FIELD

The following exemplary embodiments relate to wireless communication and to sidelink transmissions between terminal devices.

### BACKGROUND

Wireless communication may take place between terminal devices via an access node. Such communication may be seen as a hierarchical communication. While it has its benefits, there may also be communication taking place directly between two or more devices without having an access node in-between.

### BRIEF DESCRIPTION

The scope of protection sought for various embodiments is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising at least one processor, and at least one memory including a computer program code, wherein the at least one memory and the computer program code are configured, with the at least one processor, to cause the apparatus to receive a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtain data related to an event that is to be transmitted for the groupcast, transmit, outside the on-duration of the sidelink discontinuous reception cycle, a first indication comprising a notification regarding the event using the resource, and transmit the data for the groupcast.

According to a second aspect there is provided an apparatus comprising means for receiving a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtaining data related to an event that is to be transmitted for the groupcast, transmitting, outside the on-duration of the sidelink discontinuous reception cycle, a first indication comprising a notification regarding the event using the resource, and transmitting the data for the groupcast.

According to a third aspect there is provided a method comprising receiving a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtaining data related to an event that is to be transmitted for the groupcast, transmitting, outside the on-duration of the sidelink discontinuous reception cycle, a first indication comprising a notification regarding the event using the resource, and transmitting the data for the groupcast.

According to a fourth aspect there is provided a computer program comprising instructions for causing an apparatus to perform at least the following: receive a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtain data related to an event that is to be transmitted for the groupcast, transmit, outside the on-duration of the sidelink discontinuous reception cycle, a first indication comprising a notification regarding the event using the resource, and transmit the data for the groupcast.

According to a fifth aspect there is provided a computer program product comprising instructions for causing an apparatus to perform at least the following: receive a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtain data related to an event that is to be transmitted for the groupcast, transmit, outside the on-duration of the sidelink discontinuous reception cycle, a first indication comprising a notification regarding the event using the resource, and transmit the data for the groupcast.

According to a sixth aspect there is provided a computer program comprising instructions stored thereon for performing at least the following: receive a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtain data related to an event that is to be transmitted for the groupcast, transmit, outside the on-duration of the sidelink discontinuous reception cycle, a first indication comprising a notification regarding the event using the resource, and transmit the data for the groupcast.

According to a seventh aspect there is provided a non-transitory computer readable medium comprising program instructions for causing an apparatus to perform at least the following: receive a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtain data related to an event that is to be transmitted for the groupcast, transmit, outside the on-duration of the sidelink discontinuous reception cycle, a first indication comprising a notification regarding the event using the resource, and transmit the data for the groupcast.

According to an eight aspect there is provided non-transitory computer readable medium comprising program instructions stored thereon for performing at least the following: receive a configuration of a resource associated with sidelink data transmission for a groupcast to a group of terminal devices from an anchoring terminal device, wherein the sidelink data transmission for the groupcast occurs outside an on-duration of a sidelink discontinuous reception cycle, obtain data related to an event that is to be transmitted for the groupcast, transmit, outside the on-duration of the sidelink discontinuous reception cycle, a first indication comprising a notification regarding the event using the resource, and transmit the data for the groupcast.

According to a ninth aspect there is provided an apparatus comprising at least one processor, and at least one memory including a computer program code, wherein the at least one memory and the computer program code are configured, with the at least one processor, to cause the apparatus to configure a resource to a group of terminal devices, wherein the resource is associated with sidelink data transmission for a groupcast to the group and the sidelink data transmission for the groupcast occurs outside an on-duration of a sidelink discontinuous reception cycle, and monitor the resource for receiving a first indication comprising a notification of an event from at least one requesting terminal device of the group.

According to a tenth aspect there is provided an apparatus comprising means for configuring a resource to a group of terminal devices, wherein the resource is associated with sidelink data transmission for a groupcast to the group and the sidelink data transmission for the groupcast occurs outside an on-duration of a sidelink discontinuous reception cycle, and monitoring the resource for receiving a first indication comprising a notification of an event from at least one requesting terminal device of the group.

According to an eleventh aspect there is provided a method comprising configuring a resource to a group of terminal devices, wherein the resource is associated with sidelink data transmission for a groupcast to the group and the sidelink data transmission for the groupcast occurs outside an on-duration of a sidelink discontinuous reception cycle, and monitoring the resource for receiving a first indication comprising a notification of an event from at least one requesting terminal device of the group.

According to a twelfth aspect there is provided a computer program comprising instructions for causing an apparatus to perform at least the following: configure a resource to a group of terminal devices, wherein the resource is associated with sidelink data transmission for a groupcast to the group and the sidelink data transmission for the groupcast occurs outside an on-duration of a sidelink discontinuous reception cycle, and monitor the resource for receiving a first indication comprising a notification of an event from at least one requesting terminal device of the group.

According to a thirteenth aspect there is provided a computer program product comprising instructions for causing an apparatus to perform at least the following: configure a resource to a group of terminal devices, wherein the resource is associated with sidelink data transmission for a groupcast to the group and the sidelink data transmission for the groupcast occurs outside an on-duration of a sidelink discontinuous reception cycle, and monitor the resource for receiving a first indication comprising a notification of an event from at least one requesting terminal device of the group.

According to a fourteenth aspect there is provided a computer program comprising instructions stored thereon for performing at least the following: configure a resource to a group of terminal devices, wherein the resource is associated with sidelink data transmission for a groupcast to the group and the sidelink data transmission for the groupcast occurs outside an on-duration of a sidelink discontinuous reception cycle, and monitor the resource for receiving a first indication comprising a notification of an event from at least one requesting terminal device of the group.

According to a fifteenth aspect there is provided a non-transitory computer readable medium comprising program instructions for causing an apparatus to perform at least the following: configure a resource to a group of terminal devices, wherein the resource is associated with sidelink data transmission for a groupcast to the group and the sidelink data transmission for the groupcast occurs outside an on-duration of a sidelink discontinuous reception cycle, and monitor the resource for receiving a first indication comprising a notification of an event from at least one requesting terminal device of the group.

According to an sixteenth aspect there is provided non-transitory computer readable medium comprising program instructions stored thereon for performing at least the following: configure a resource to a group of terminal devices, wherein the resource is associated with sidelink data transmission for a groupcast to the group and the sidelink data transmission for the groupcast occurs outside an on-duration of a sidelink discontinuous reception cycle, and monitor the resource for receiving a first indication comprising a notification of an event from at least one requesting terminal device of the group.

### LIST OF DRAWINGS

In the following, the exemplary embodiments will be described in greater detail with reference to the embodiments and the accompanying drawings, in which

FIG. 1 illustrates an exemplary embodiment of sidelink communication between terminal devices.

FIG. 2 illustrates an exemplary embodiment of data transmissions of sidelink data transmission for a groupcast.

FIG. 3 illustrates a flow chart according to an exemplary embodiment.

FIG. 4 illustrates an exemplary embodiment of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Sidelink communication may be understood as communication between terminal devices, which may also be called as user equipments (UEs), in which the terminal devices connect to each other directly without an access node involvement, in other words, without relaying the data via a network such as a cellular communication network. Such terminal devices may be of any suitable type such as mobile phones, vehicles, robots or wearable consumer electronic devices. Sidelink communication may be enabled for example by 5G and/or 4G technology. Sidelink communication may be beneficial for example to allow devices with close proximity to each other to discover and connect to each other at high data rates and low latency. This may be useful for example in public-safety communication, vehicle communication, peer-to-peer gaming, and streaming services. Also enhanced augmented reality and/or virtual reality may benefit from sidelink communication.

In sidelink communication, resource allocation as well as link adaptation may be controlled by the terminal devices independently, which allows more control over usage of resources to a terminal device. As sidelink communication allows reduction in latency due to being restricted to one hop, it may be useful for example in mission-critical communication and industrial applications.

If sidelink discontinuous reception (SL DRX) is not used, then it may be that a terminal device receiving sidelink (SL) transmission is to monitor and be awake for a possible transmission to be received all the time, which consumes a lot of battery power. As a number of services used in sidelink communication allow periodic transmissions from a transmitting (Tx) terminal device to a receiving (Rx) terminal device, this periodic manner may be taken into account in sidelink design. For example, 5G sidelink for vehicle-to-everything (V2X) have taken the periodic manner of sidelink transmission into account in their design. Thus, for example a Tx terminal device using sidelink for its transmission may transmit sidelink control information, SCI, to indicate its transmission periodicity and future periodic resources that will be used for its (re) transmissions to the Rx terminal device.

As described above, a terminal device participating in sidelink communication may participate in managing its sidelink resource allocation and/or sidelink resource selection as well. Therefore, if a Tx terminal device is to periodically transmit transmissions for a service to a Rx terminal device, traffic pattern and characteristics of the traffic are to be taken into account in periodic resource allocation or periodic resource selection. Examples of traffic pattern and characteristics comprise for example generation time of data, its periodicity, size and quality of service requirement. If the Rx terminal device receives from the Tx terminal device an SCI indicating and reserving future transmission resources, it is then aware of the transmissions that are to take place and may monitor resources correspondingly to be able to receive the transmissions from the Tx terminal device. Alternatively, the Rx terminal device may receive an indication indicative of one or more sidelink resources from the Tx terminal device and based on that indication, the Rx terminal device may reserve the one or more sidelink resources for future transmissions from the Tx terminal device.

It is to be noted that the future transmissions may be considered as subsequent or expected transmissions as well. The transmissions over the indicated/reserved resources may be used for periodic transmissions and/or re-transmissions. This allows the Rx terminal device to limit monitoring of sidelink transmissions to the resources indicated in the SCI which allows its power to be saved.

Sidelink communication may be used for various types of services that require data to be transmitted from a Tx terminal device to one or more Rx terminal devices. The data transmission may be performed in a periodic manner and the Tx terminal device and the one or more Rx terminal devices may form a group. If the data transmission is transmitted to all of the Rx terminals belonging to the group, the data transmission may be understood to be a groupcast that is performed using the sidelink communication. Thus, to facilitate the periodic data transmission for a service, traffic pattern and characteristics of the periodic data transmission are to be considered for enabling corresponding periodic resource allocation. The traffic pattern may be supported using a sidelink discontinuous reception cycle that beings with an on-duration that is then followed by an off-duration. The resource allocation may be performed for example by a network in one sidelink resource allocation mode, referred to as mode 1, or by the Tx terminal device autonomously in another sidelink resource allocation mode, referred to as mode 2. For example, a generation time offset of the data to be transmitted, periodicity of the data transmission, size and quality of service requirement may be considered to allocate and/or select resources for the periodic data transmission.

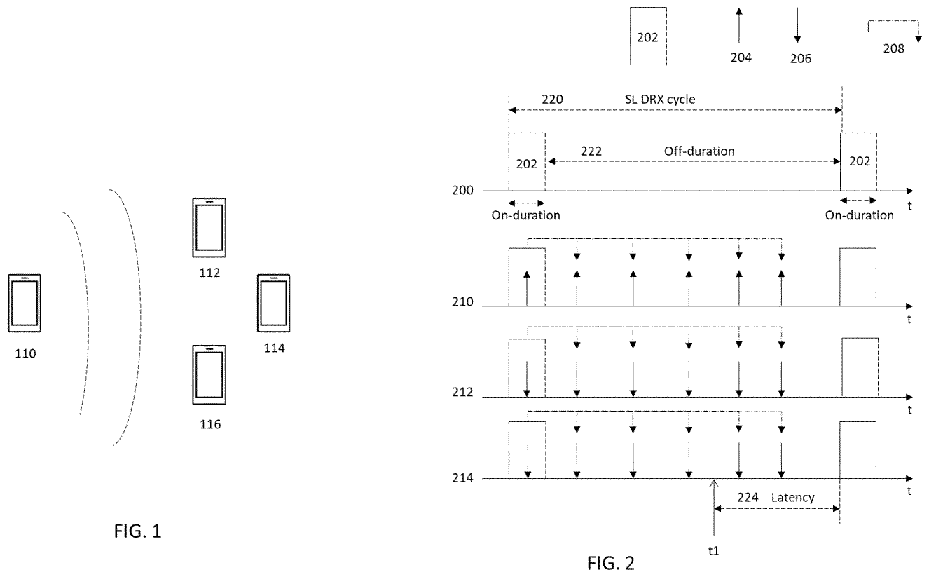

FIG. 1 illustrates an exemplary embodiment in which a groupcast using sidelink takes place. A terminal device 110 is in this exemplary embodiment a Tx terminal device and terminal devices 112, 114 and 116 are Rx terminal devices that receive the data transmissions transmitted using sidelink communication from the terminal device 110. Terminal devices 110, 112, 114 and 116 are thus part of the same group within which the groupcast over sidelink takes place. In this exemplary embodiment, the SL DRX configuration (e.g., SL DRX cycle, on-duration/off-duration) for the SL groupcast is obtained by each terminal device and the obtaining may have taken place in any suitable manner. For example, a terminal device may use a SL DRX configuration provided by network, if the terminal device is under network coverage, such as within a cell provided by an access node such as an eNB or a gNB. As another example, if a terminal device is not within coverage of the network, the terminal device may be pre-configured with the corresponding SL DRX configuration. The terminal device 110 performs data transmission, that may be part of a service provided using SL communication, in accordance with the transmission pattern and as a groupcast. Although there is one Tx terminal device and three Rx terminal devices in this exemplary embodiment, it is to be noted that in some other exemplary embodiments there may be more than one Tx terminal devices and a different amount of Rx terminal devices that form the group for the SL groupcast. Furthermore, a terminal device of the group may be acting as a Tx terminal device or a Rx terminal device for the SL groupcast of the group from time to time in group communication.

FIG. 2 illustrates an exemplary embodiment of SL groupcast transmissions. Timeline 200 illustrates the SL DRX configuration in which on-durations 202 are visible. The SL DRX cycle for a groupcast is illustrated as 220 and the off-duration 222 is also illustrated. Timeline 210 is a timeline for a Tx terminal device performing the data transmissions as a SL groupcast and timelines 212 and 214 illustrate timelines for two Rx terminal devices that receive the SL groupcast transmissions. A data transmission from the Tx terminal device is illustrated by arrow 204 and a data transmission that is received by an Rx terminal device is illustrated by arrow 206. As can be seen from FIG. 2, the Tx terminal device transmits the first data transmission, which may also be understood as an initial data transmission, during an on-duration 202. The first data transmission may occur once the Tx terminal device has obtained the data to be transmitted. Obtaining the data to be transmitted may be understood as generating the data. The first transmission then occurs during the next on-duration as the Rx terminal devices are configured to monitor for a SL transmission during that on-duration.

In the initial SL data transmission, the Tx terminal device may further indicate the future reserved resources 208 for its SL data transmissions, which may be periodic and/or re-transmission. The indicating may be performed for example by using information elements (IEs) “Frequency resource assignment”, “Time resource assignment”, and/or “Resource reservation period” carried in the associated 1st stage SCI of the first transmission. Thus, after the Rx terminal devices receive the SCI and/or data in the first data transmission transmitted by the Tx terminal device, they may be aware of the future resources that will be used by the Tx terminal device for transmissions towards the Rx terminal devices. Thus, Rx terminal devices may decide to monitor only the indicated resources outside the SL DRX on-duration 202 or, that is, during the SL DRX off-duration 222 of the SL DRX cycle 220 for power saving purpose. In other words, they may not monitor other SL resources, that is resources that were not indicated by the Tx terminal device, for at least for some period of time, such as until the reserved resources are not valid or until the next SL DRX on-duration. It is to be noted though that any transmission from the Tx terminal device may indicate future reserved resource(s).

In this exemplary embodiment, at time instance t1, one of the Rx terminal devices obtains data, that is to be groupcasted to the same group of terminal devices. Obtaining the data may comprise generating the data to be transmitted as a groupcast to the group. The data may be related to an event that has occurred for example as part of a service provided using SL communication. If the Rx terminal device is to wait until the next SL DRX on-duration 202, that is the SL DRX on-duration of the next SL DRX cycle, before indicating that it has data to be transmitted, then in addition to the delay caused by obtaining the data, also delay 224 is added to the time that is to be waited until the terminal device can perform its first/initial groupcast transmission, as that is the next time instance when it is ensured that all other group members, that is other terminal devices of the group, monitor for SL reception. This monitoring may be monitoring a PC5 interface according to 3GPP standards. Besides the introduced latency for the first, which may also be understood as an initial, groupcast transmission, postponing the groupcast to the next SL DRX on-duration may impact performance in various manners. For example, if the next SL DRX on-duration is used by multiple Tx terminal devices in the group, it may cause resource congestion and/or collision, which may reduce reliability. As another example, postponing the groupcast may limit the number of retransmissions, which may be hybrid automatic repeat request (HARQ)-feedback-based retransmissions, since media access control (MAC) layer would discard the retransmission of a transport block (TB) if the packet delay budget (PDB) expires, even though the packet has not been successfully received by the intended Rx terminal devices. This may occur even though postponing the SL transmission does not necessarily cause the expiry of the packet delay budget (PDB) for the initial transmission of the packet. It is further to be noted that in some exemplary embodiments there may be multiple terminal devices within the group that start to perform their first transmission to indicate their future reserved resources. This may occur for example during the next SL DRX on-duration. In such exemplary embodiments the terminal devices would need to monitor the resources indicated by those multiple terminal devices outside the SL DRX on-duration, respectively.

A terminal device that has indicated its reserved resources to the members of the groups, such as a terminal device having a timeline 210 illustrated in FIG. 2, for the members to monitor outside the SL DRX on-duration may be referred to as an anchoring terminal device. The other members of the group, or at least those members which obtain data that is to be groupcasted to the group during the SL DRX off-duration, may be referred to as requesting terminal devices. It is to be noted that there may be more than one anchoring terminal device and/or one or more requesting terminal devices belonging to a group. It is to be noted that outside a SL DRX on-duration may be understood as the time period, such as an off-duration, that occurs outside an on-duration of a sidelink discontinuous reception cycle.

In an exemplary embodiment, there is a group of terminal devices and SL communication is enabled. In this exemplary embodiment, the terminal devices have been configured with the SL DRX cycle and on/off-duration that is followed for groupcasting. An anchoring terminal device then indicates to other SL group members regarding the reserved PSCCH and/or PSSCH resources for its groupcasts, i.e., sidelink data transmissions, to the group, wherein the indicated PSCCH and/or PSSCH resources are outside a SL DRX on-duration. The one or more requesting terminal devices within the group are then configured with at least one resource, that in this exemplary embodiment is a specific physical sidelink feedback channel (PSFCH) resource, that is associated with the indicated PSCCH/PSSCH resources, and thus with SL transmission received from the anchoring terminal device, and which may be used by the at least one requesting terminal device for indicating an event. The event may be such that it causes a need to start a SL data transmission to the group by the requesting terminal device during the SL DRX off-duration. The requesting terminal device thus uses the PSFCH resource associated with the SL data transmission from the anchoring terminal device or, i.e., reserved PSCCH and/or PSSCH resources thereof as indicated by the anchoring terminal device, to provide an indication regarding the event to the anchoring terminal device outside the SL DRX on-duration. The indication may be referred to as a first indication and the first indication comprises a notification regarding the event and the need to transmit data regarding the event as a groupcast to the group using the SL communication. The first indication may comprise further information related to the expected SL data transmission such as latency budget, for example packet delay budget (PDB), for the SL data to be transmitted from the requesting terminal device and/or priority level of the SL data to be transmitted by the requesting terminal device.

As the anchoring terminal device receives the first indication, the anchoring terminal device may, optionally, transmit a second indication indicating the event to the group over the indicated PSCCH/PSSCH resources. The second indication may then trigger the other terminal devices in the group to remain active before the next SL DRX on-duration for monitoring PC5 interface for example. If the anchoring terminal device receives event indications from multiple requesting terminal devices, the SL DRX on-duration may then be extended in accordance with the number of events indicated by the multiple requesting terminal devices. It is to be noted that those multiple requesting terminal devices may be part of the same group as in which the SL groupcast takes place.

In another option, as the anchoring terminal device receives the first indication regarding the event from the specific PSFCH resource, the anchoring terminal device may be triggered not to transmit SL using one of indicated PSCCH/PSSCH resources. Instead, the requesting terminal device may transmit its SL data transmission, as a groupcast to the group over sidelink, using the non-used indicated PSCCH/PSSCH resources from the anchoring terminal device.

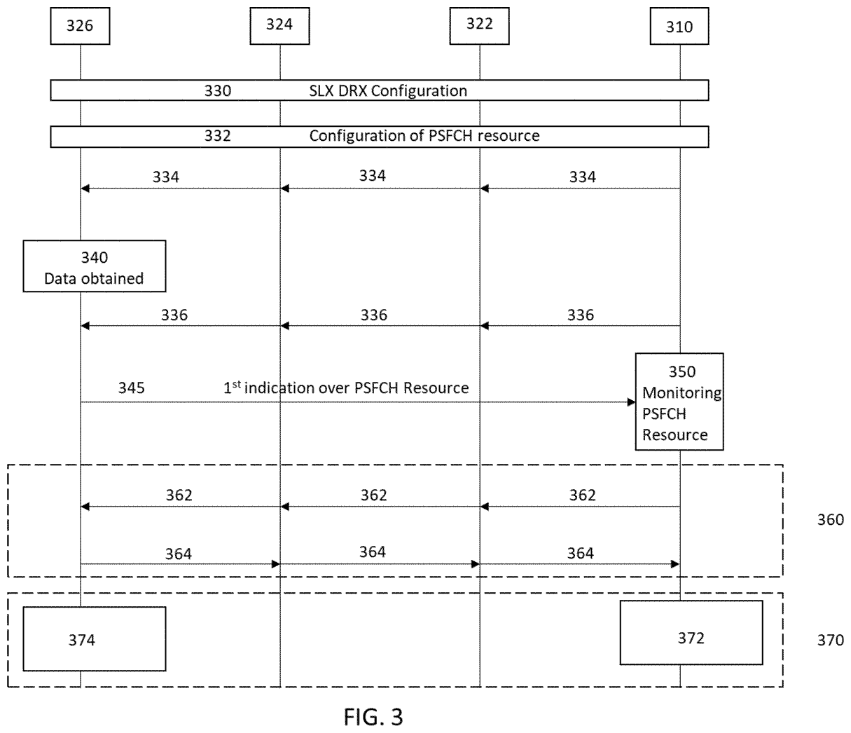

FIG. 3 illustrates a flow chat according to an exemplary embodiment. In this exemplary embodiment there are four terminal devices, an anchoring terminal device 310 and three requesting terminal devices 322, 324 and 326. The terminal devices are considered to belong to a group and sidelink communication can be used for groupcasting data transmissions to the group. In this exemplary embodiment, a SL DRX configuration (e.g., SL DRX cycle and on/off-duration) is provided 330 to all group members, that is, to all terminal devices within the group. The configuration may be provided in any suitable manner. Thus, the terminal devices are considered to obtain the SL DRX configuration.

Next, a PSFCH resource, that is associated with a sidelink data transmission that is provided by the anchoring terminal device 310, is configured. The sidelink data transmission is, in this exemplary embodiment, for a groupcast to the group. The terminal devices within the group thus obtain a configuration regarding the PSFCH resource, or resources, and the requesting terminal devices 322, 324 and 326 may then use the configured PSFCH resource to transmit an indication, which may be referred to as a first indication, indicating an event to at least the anchoring terminal device 310. The event may comprise obtaining data that is to be transmitted to the group using sidelink communication, for example as a groupcast to the group. Obtaining the data may comprise generating the data to be transmitted. The PSFCH resource(s) associated with the sidelink data transmission from the anchoring terminal device 310, wherein the sidelink data transmission uses PSCCH and/or PSSCH resources previously indicated to the group. Thus, the detailed resource used in time, frequency, and/or code domain for the PSFCH resource(s) may be determined by the PSCCH/PSSCH resource(s) indicated and used by the anchoring terminal device for the groupcast transmission. Optionally, the PSFCH resource(s) may be configured to take place in the same time slot as the PSFCH resource(s) carrying the HARQ feedback(s) for the groupcasted PSCCH/PSSCH transmission. Thus, the anchoring terminal device may monitor just one PSFCH slot to receive the HARQ feedback(s) and the first indication from a requesting terminal device. It is to be noted that in some exemplary embodiments, the PSFCH resource may be a different PSFCH resource in frequency and/or code domain than a PSFCH resource(s) used for HARQ feedback(s). It is also to be noted that the PSFCH resource may be configured to more than one group member and thus multiple requesting terminal devices may use the same PSFCH resource in a single frequency network (SFN) manner to transmit the first indication to at least the anchoring terminal device if they all have new data that is to be transmitted to the group. In this case the anchoring terminal device may not be able to differentiate the requesting terminal devices but is still notified that there is at least one requesting terminal device with data to be transmitted as a groupcast to the group over the sidelink connection.

Additionally, the configuration associated to the PSFCH resource may further comprise criteria regarding usage of the PSFCH resource, such as traffic priority, periodic/aperiodic transmission and/or latency requirement. For example, a requesting terminal device may use the specific PSFCH resource in case the new generated data has a priority higher and/or a latency requirement lower than a configured threshold. Further, the priority threshold may be related to the priority of the original transmission from the anchoring terminal device. For example, a requesting terminal device may use the PSFCH resource only if the new generated data has a priority higher than the priority of the original transmission from the anchoring terminal device. In this case, an indication transmitted over the specific PSFCH resource may indicate further information related to the expected SL data transmission.

In some exemplary embodiments, a group member, such as terminal device 322, 324, and/or 326, may be configured with multiple PSFCH resources for indicating an event to one anchoring terminal device, such as terminal device 310, wherein the different PSFCH resources configured may be associated to different criterions. For example, a requesting terminal device may select a proper PSFCH resource to indicate its activity event based on the criterions associated to each PSFCH resource. Also, in some exemplary embodiments, the different PSFCH resources configured may be associated to different anchoring terminal devices. For example, for each groupcast outside the SL DRX on-duration, a group member may be configured with at least one PSFCH resource, independent from the groupcast transmitter. Thus, if there are multiple groupcast transmitters outside the SL DRX on-duration, the group member is allowed to use any of the configured PSFCH resources associated with the PSCCH/PSSCH groupcasts and a requesting terminal device may select one PSFCH resource associated to a specific anchoring terminal device by considering its data traffic characters. For example, the requesting terminal device may select a specific PSFCH resource that is upcoming next, in order to reduce latency after the data is generated or the requesting terminal device may select a proper PSFCH resource based on the associated criterion, such as if the generated data has a low priority, it has to use such PSFCH resource that allows a low priority data indication.

In some exemplary embodiments, multiple PSFCH resources may be associated with an indicated PSCCH/PSSCH resource, wherein the different PSFCH resources may be configured to different group members. In this case, the anchoring terminal device may be able to differentiate between different requesting terminal devices in case multiple indications indicating events are received by the anchoring terminal device. Further, in some exemplary embodiments, PSFCH resource may also be associated with one of the indicated PSCCH/PSSCH resources from anchoring terminal devices such that the one of the indicated PSCCH/PSSCH resources may not be used by the anchoring terminal device for its own SL transmission. For example, one of the indicated PSCCH/PSSCH resources may be configured by a pattern such as the last indicated PSCCH/PSSCH resources in every N indicated PSCCH/PSSCH resources may not be used by the anchoring terminal, where N may be configured based on group size, the number of active/inactive group members, etc. For example, the PSFCH resources may occur earlier than the PSCCH/PSSCH resource which may not be used by the anchoring terminal device. This may be achieved for example by taking into account processing time required by a terminal device for receiving the indication over a PSFCH resource at the anchoring terminal device. Also, the different associated PSCCH/PSSCH resources may be configured to different requesting terminal devices such that there will not be conflict among their SL transmissions.

It is to be noted that the configuration of the PSFCH resource may be performed in any suitable manner such as by a network, according to a technical specification, using signalling within the group, by having terminal devices pre-configured, etc. If the configuration is performed by a network, the terminal device may obtain the configuration from an access node. It is to be noted that in some exemplary embodiments, the configuration of the PSFCH resource may be performed together with any suitable signalling that is transmitted by the anchoring terminal device 310 to the requesting terminal devices 322, 324 and 326.

Next, in this exemplary embodiment, the anchoring terminal device indicates 334 the future reserved PSCCH/PSSCH resources for its groupcasts to the group via, for example, the SCI over a 1st groupcast (i.e., the SCI of the first data transmission or the initial data transmission from the anchoring terminal device to the group over sidelink), wherein at least some of the indicated resources are outside the SL DRX on-duration. For example, the SCI over the 1st groupcast may be transmitted inside the SL DRX on-duration of the group. Thus, it allows the group members to monitor only the indicated resources outside the SL DRX on-duration. Optionally, the transmission from the anchoring terminal device 310 may further comprise configuration and/or activation of the PSFCH resource that is to be used for the first indication. Further, optionally, when the anchoring terminal device 310 indicates the future reserved PSCCH/PSSCH resources for its groupcasts to the group, the anchoring terminal device 310 may also indicate which reserved PSCCH/PSSCH resource(s) may not be used by the anchoring terminal device 310 for its own SL transmissions. It may further indicate which requesting terminal device can use the non-used reserved PSCCH/PSSCH resources for its SL transmission.

Next, in this exemplary embodiment, a requesting terminal device, such as the requesting terminal device 326, generates data 340 at a time that is outside the configured SL DRX on-duration of the group. If the requesting terminal device 326 has a configuration regarding PSFCH resources associated with different groupcasts from anchoring terminal devices other than the anchoring terminal device 310, the requesting terminal device 326 may determine the proper anchoring terminal device to which the first indication regarding the event that caused the data to be generated is to be transmitted.

The anchoring terminal device 310 then transmits a data transmission 336 outside the SL DRX on-duration using the PSCCH/PSSCH resources indicated previously. This transmission, which is respectively received by the receiving terminal devices 322, 324 and 326, is associated with the configured PSFCH resource. The PSCCH/PSSCH transmission from the anchoring terminal device 310 may further comprise the configuration and/or activation of the configured PSFCH resource. Additionally, in some exemplary embodiments, the PSCCH/PSSCH transmission received by the requesting terminal device 326, should be from one of the configured anchoring terminal devices in case the requesting terminal device 326 is configured with multiple anchoring devices.

The anchoring terminal device 310 then monitors 350 the PSFCH resource that is configured and is associated with the PSCCH/PSSCH transmission for the first indication. In this exemplary embodiment, the requesting terminal device 326 transmits 345 the first indication regarding the event using the PSFCH resource. And as the anchoring terminal device 310 monitors the PSFCH resource, it receives the first indication indicating the event. As the PSFCH resource may occur in the same slot as such PSFCH resource(s) that are used for carrying the HARQ feedback(s), the anchoring terminal device 310 may monitor the same PSFCH slot for receiving both the first indication from a potential requesting terminal device of the group and the HARQ feedback(s).

As mentioned above, in this exemplary embodiment the requesting terminal device 326 transmits an indication regarding the event or, that is the first indication, to the anchoring terminal device 310. If the requesting terminal device 326 receives a PSCCH/PSSCH transmission that associates to multiple PSFCH resources that can be used by the requesting terminal device 326, the requesting terminal device 326 may determine a proper PSFCH resource to be used for transmitting the first indication based on, for example, the criterions associated to each of the PSFCH resources. Additionally, as the requesting terminal device 326 is an intended receiver of the PSCCH/PSSCH transmission, the requesting terminal device 326 may also transmit its HARQ feedback to the anchoring terminal device 310.

Once the anchoring terminal device 310 receives the first indication from the requesting terminal device 326, the anchoring terminal device 310 may then transmit a second indication to the group using at least one of the indicated PSCCH/PSSCH resources. The second indication thus indicates the event, that was notified using the first indication, to the group. The second indication may be transmitted for example via one reservation bit in the first stage SCI, a second stage SCI, a new media address control (MAC) control element (CE), and/or an upper layer message. Transmitting the second indication to the group may trigger all group members to stay awake and monitor the PC5 interface outside the configured SL DRX on-duration in order to receive data, that is the data relating to the event and obtained by the requesting terminal device 326, from the requesting terminal device 326.

Alternatively, the second indication may be a resource allocation. For example, if the different group members are configured with different PSFCH resources, the anchoring terminal device 310 may be able to detect the requesting terminal devices that have transmitted a first indication in case multiple requesting terminal devices have transmitted a first indication. Thus, the anchoring terminal device 310 may transmit the resource allocations to the detected requesting terminal devices accordingly.

Additionally, the second indication may further be associated with or indicate a SL time- and/or frequency domain window that the group members are to monitor. In case the second indication is a resource allocation, the allocated resource may indicate the SL time- and/or frequency domain window that the group members need to monitor. Additionally, an additional wake-up time may be configured for example based on the service that is to be provided by the data that is to be transmitted by the requesting terminal device 326, the group size, and/or the reserved resources of the anchoring terminal device 310.

In some exemplary embodiments, the second indication may be transmitted by the anchoring terminal device 310 in any of the indicated PSCCH/PSSCH resources, which requires all the group members to monitor all the indicated retransmission (ReTX) resources no matter if they have successfully received the transmission block (TB) before. This may have an advantage of bringing more flexibility and reliability although it may introduce additional power consumption for at least some of the group members to monitor the ReTX resources. Further, in some exemplary embodiments, the second indication may be transmitted by the anchoring terminal device 310 in an indicated PSCCH/PSSCH resources used for transmitting a new TB. The indicated PSCCH/PSSCH resources may be for example the next ones. In this case, a group member may skip monitoring an indicated ReTX resource if it has successfully received the TB before, which allows the group members to save their power without missing the reception of the second indication.

In this exemplary embodiment, once the anchoring terminal device 310 transmits to the group an indication 362 regarding the event, the requesting terminal device 326 then transmits the data regarding the event to the group as a sidelink groupcast. Transmission of the data may be within the SL time- and/or frequency domain window provided by the event indication from the anchoring terminal device 310.

Optionally, in option 360, the anchoring terminal device 310 may transmit third indication, which is a separate event indication, to the requesting terminal device 326. This may occur for example after receiving HARQ feedbacks from all group members in case the groupcast of the second indication 362 from the anchoring terminal device is based on using sidelink HARQ with dedicated feedback enabled for groupcast, referred to as SL HARQ option 2 in 3GPP standards. This may have the benefit of ensuring that all group members are awake and ready to receive the data transmitted 364 by the requesting terminal device 326.

Optionally, in option 370, upon receiving the first indication from at least one requesting terminal device over the PSFCH resource, the anchoring terminal device 310 may determine not to use one of indicated PSCCH/PSSCH resources for its own SL transmission. Instead, the indicated PSCCH/PSSCH resource will be used by the requesting terminal device for its SL transmission. For example, the indicated PSCCH/PSSCH resources will be determined by the anchoring terminal device 310 and the requesting terminal device 326, which allows the PSCCH/PSSCH resources be synchronized among the anchoring terminal device 310 and the requesting terminal device 326. Additionally, or alternatively, the anchoring terminal device 310 may be triggered to indicate more reserved PSCCH/PSSCH resources in the SL transmission of next indicated PSCCH/PSSCH resources and indicate that the additional reserved PSCCH/PSSCH resources are used for SL transmission of the requesting terminal device 326.

It is to be noted that the exemplary embodiments described above take place in a resource pool with PSFCH resources configured. In addition, a PSFCH resource refers to a resource in time- and-frequency- and-code domain in the exemplary embodiments discussed herein.

In some exemplary embodiments, the first indication comprising an event notification from a requesting terminal device to the anchoring terminal device may also be divided into two stages, as follows. The first stage may comprise a first indication comprising an indication of the event to be transmitted by the requesting terminal device via the configured PSFCH resource. The second stage may comprise the anchoring terminal device to monitor for another indication comprising a detailed notification from the requesting terminal device. This exemplary embodiment enables the requesting terminal device to indicate different kinds of events to the anchoring terminal device.

In some exemplary embodiments, robustness of the first indication from the requesting terminal device to the anchoring terminal device may be enhanced for example by the anchoring terminal device using and/or scheduling at least 1 additional (re) transmission upon receiving the first indication and the requesting terminal device repeating the first indication comprising the event notification twice.

In some exemplary embodiments, the requesting terminal device may transmit its first indication to multiple anchoring terminal devices or to one anchoring terminal device for multiple times. The multiple anchoring terminal device(s) may attempt to wake up their respective groups accordingly. This may introduce a diversity gain and further enhance the robustness.

In some exemplary embodiments, the requesting terminal device is allowed to transmit NACK for HARQ feedback to the anchoring terminal device even if it decoded the TB from the anchoring terminal device correctly. In this case, if the anchoring terminal device missed the event indication, that is the first indication from the requesting terminal device, but received the NACK, or detected absence of ACK for SL groupcast with SL HARQ option 2, it will perform re-transmission, which gives the requesting terminal device another opportunity to transmit the event indication. Additionally, if the anchoring terminal device can indicate in its re-transmission that it has received the first indication, the requesting terminal device does not repeat sending the first indication.

It is also to be noted that the exemplary embodiments described herein can work no matter if the anchoring terminal device requires HARQ feedback(s) for its groupcast or not. In case the anchoring terminal device does not required HARQ feedback(s), as one example, the anchoring terminal device may indicate in an SCI regarding if it monitors the specific PSFCH resource(s) for first indication(s) that comprise event indication(s).

The exemplary embodiments described herein allow to wake up group members for an upcoming event on the fly while allowing possible use of a SL DRX configuration with a long off-duration. It is also to be noted that the exemplary embodiments described above do not preclude the exemplary embodiments in which multiple requesting terminal devices have indicated their reserved resources to their considered group, and/or multiple group members have data generated during the off-duration or, that is, outside the on-duration of a given SL DRX cycle.

Embodiments described herein may be compatible with a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

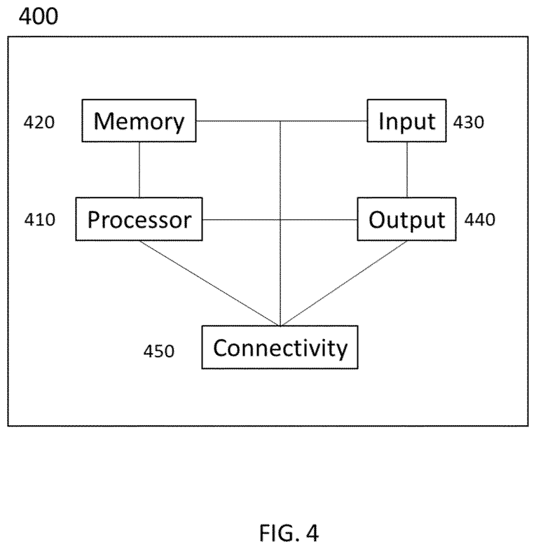

FIG. 4 illustrates an apparatus 400, which may be an apparatus such as, or comprised in, a terminal device, according to an example embodiment. The apparatus 400 comprises a processor 410. The processor 410 interprets computer program instructions and processes data. The processor 410 may comprise one or more programmable processors. The processor 410 may comprise programmable hardware with embedded firmware and may, alternatively or additionally, comprise one or more application specific integrated circuits, ASICs.

The processor 410 is coupled to a memory 420. The processor is configured to read and write data to and from the memory 420. The memory 420 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 420 stores computer readable instructions that are execute by the processor 410. For example, non-volatile memory stores the computer readable instructions and the processor 410 executes the instructions using volatile memory for temporary storage of data and/or instructions.

The computer readable instructions may have been pre-stored to the memory 420 or, alternatively or additionally, they may be received, by the apparatus, via electromagnetic carrier signal and/or may be copied from a physical entity such as computer program product. Execution of the computer readable instructions causes the apparatus 400 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 400 further comprises, or is connected to, an input unit 430. The input unit 430 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 430 may comprise an interface to which external devices may connect to.

The apparatus 400 also comprises an output unit 440. The output unit comprises or is connected to one or more displays capable of rendering visual content such as a light emitting diode, LED, display, a liquid crystal display, LCD and a liquid crystal on silicon, LCoS, display. The output unit 440 further comprises one or more audio outputs. The one or more audio outputs may be for example loudspeakers or a set of headphones.

The apparatus 400 may further comprise a connectivity unit 450. The connectivity unit 450 enables wired and/or wireless connectivity to external networks. The connectivity unit 450 may comprise one or more antennas and one or more receivers that may be integrated to the apparatus 400 or the apparatus 400 may be connected to. The connectivity unit 450 may comprise an integrated circuit or a set of integrated circuits that provide the wireless communication capability for the apparatus 400. Alternatively, the wireless connectivity may be a hardwired application specific integrated circuit, ASIC.

It is to be noted that the apparatus 400 may further comprise various component not illustrated in the FIG. 4. The various components may be hardware component and/or software components.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

As used herein, the term “determining” (and grammatical variants thereof) may include: calculating, computing, processing, deriving, measuring, investigating, looking up (e.g., looking up in a table, a database or another data structure), ascertaining and the like. Also, “determining” may include receiving (e.g., receiving information), accessing (e.g., accessing data in a memory), obtaining and the like. Also, “determining” can include resolving, selecting, choosing, establishing, and the like.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor, and at least one memory including a computer program code, wherein the at least one memory and the computer program code are configured, with the at least one processor, to cause the apparatus to:
receive a configuration of a resource associated with sidelink data transmission for a groupcast to a group of terminal devices from an anchoring terminal device, wherein the sidelink data transmission for the groupcast occurs outside an on-duration of a sidelink discontinuous reception cycle;
obtain data related to an event that is to be transmitted for the groupcast;
transmit, outside the on-duration of the sidelink discontinuous reception cycle, a first indication comprising a notification regarding the event using the resource; and
transmit the data for the groupcast.

2. An apparatus according to claim 1, wherein the apparatus is further caused to transmit the data outside the on-duration of the sidelink discontinuous reception cycle.

3. An apparatus according to claim 1, wherein the apparatus is further caused to transmit the data using physical sidelink control channel and/or physical sidelink shared channel resources indicated by the anchoring terminal device.

4. An apparatus according to claim 1, wherein the resource is a physical sidelink feedback channel resource.

5. An apparatus according to claim 1, wherein the first indication further comprises information regarding the data.

6. An apparatus according to claim 5, wherein the information regarding the data comprises one or more of the following: latency budget for transmitting the data or priority level for transmitting the data.

7. An apparatus according to claim 1, wherein the apparatus is further caused to transmit the first indication to the anchoring terminal device.

8. An apparatus according to claim 1, wherein the apparatus is further caused to receive another configuration of another resource, wherein the other resource is associated with the sidelink data transmission for the groupcast from the anchoring terminal device or the other resource is associated with another sidelink data transmission from another anchoring terminal device of the group.

9. An apparatus comprising at least one processor, and at least one memory including a computer program code, wherein the at least one memory and the computer program code are configured, with the at least one processor, to cause the apparatus to:
configure a resource to a group of terminal devices, wherein the resource is associated with sidelink data transmission for a groupcast to the group and the sidelink data transmission for the groupcast occurs outside an on-duration of a sidelink discontinuous reception cycle; and
monitor the resource for receiving a first indication comprising a notification of an event from at least one requesting terminal device of the group.

10. An apparatus according to claim 9, wherein the apparatus is further caused, upon receiving the first indication, to transmit a second indication indicating the event to the group, or to monitor physical sidelink control channel and/or physical sidelink shared channel resources indicated by the apparatus for sidelink data transmission for the groupcast to the group for receiving a sidelink data transmission from the at one requesting terminal device of the group for the event.

11. An apparatus according to claim 9, wherein the second indication causes the group to remain active and monitor for sidelink data transmission regarding the event outside the on-duration of the sidelink discontinuous reception cycle.

12. An apparatus according to claim 9, wherein the apparatus is further caused to receive the first indication from multiple requesting terminal devices of the group.

13. An apparatus according to claim 12, wherein the apparatus is further caused to extend the on-duration of the sidelink discontinuous reception cycle.

14. An apparatus according to claim 9, wherein the apparatus is further caused to configure a plurality of the resource and allocate different resources to different requesting device terminals of the group.

15. An apparatus according to claim 9, wherein the apparatus is further caused to indicate to the group physical sidelink control channel and/or physical sidelink shared channel resources that are not to be used for the sidelink data transmission by the apparatus for the groupcast outside the on-duration of the sidelink discontinuous reception cycle.

16. An apparatus according to claim 9, wherein the resource is a physical sidelink feedback channel resource.

17. A method comprising:
receiving a configuration of a resource associated with sidelink data transmission for a groupcast to a group of terminal devices from an anchoring terminal device, wherein the sidelink data transmission for the groupcast occurs outside an on-duration of a sidelink discontinuous reception cycle;
obtaining data related to an event that is to be transmitted for the groupcast;
transmitting, outside the on-duration of the sidelink discontinuous reception cycle, a first indication comprising a notification regarding the event using the resource; and
transmitting the data for the groupcast.

18-20. (canceled)
